(19) United States
(12) Patent Application Publication
(10) Pub. No.: US 2026/0187230 A1
(43) Pub. Date: Jul. 2, 2026

(54) INCIDENT DATA MANAGEMENT FOR COMPUTING ENVIRONMENTS

(71) Applicant: Microsoft Technology Licensing, LLC, Redmond, WA (US)

(72) Inventors: Jordan Lee James HULL, Astoria, NY (US); Abhilasha BHARGAV-SPANTZEL, El Dorado Hills, CA (US); Jonathan Michael LOEFFELHOLZ, Holmen, WI (US)

(21) Appl. No.: 19/003,162

(22) Filed: Dec. 27, 2024

(51) Int. Cl. G06F 21/55; G06F 21/62

(52) U.S. Cl. CPC G06F 21/552; G06F 21/6245

(57) ABSTRACT

Systems, methods, and software are disclosed herein for incident data management in computing environments, including data collection, processing, and reporting, in various implementations. In one example, a method of responding to security incidents comprises receiving a record indicative of a security incident in a computing environment; identifying one or more other records of the computing environment associated with the security incident; prompting a generative AI model to generate redaction criteria, based on security incident data in the records, for redacting sensitive information from the security incident data; processing the security incident data based on the redaction criteria to produce redacted incident data; and prompting the generative AI model to generate a report of the incident based on the redacted incident data.

### TECHNICAL FIELD

Aspects of the disclosure are related to incident data management for cloud computing environments including the redaction of sensitive information.

### BACKGROUND

Computing environments for enterprise support, such as cloud computing environments, include services such as infrastructure management, network administration, cybersecurity, data storage solutions, and application development and operation. To ensure system reliability and performance, computing environments may use service management platforms which provide a centralized framework for managing and optimizing information technology (IT) services, for example, by streamlining processes relating to incident management, problem resolution, and change management. Such platforms often include ticketing systems, automated workflows, and integrated monitoring and alert systems to detect and respond to incidents or anomalies as they arise.

Given the breadth of operations hosted by a computing environment, when a data breach occurs in such an environment, information about the incident may accrue across different platforms hosted by the computing environment in an effort to mitigate or take corrective action to resolve the breach. For example, users or clients may report performance issues, service disruptions, or other anomalies by submitting support tickets or contacting help desks. These reports can provide valuable first-hand accounts of irregularities, such as failed logins, missing data, or unexpected system behavior. However, low transparency in computing environments, where information about incidents is not effectively shared, can hinder a timely and effective response to an incident while also limiting opportunities for organizational learning and improvement. When data remains siloed or inaccessible, teams may not fully understand the root causes of incidents or leverage past experiences to enhance processes or security. This lack of visibility also perpetuates inefficiencies as similar mistakes or vulnerabilities may reoccur. Furthermore, even when information is shared, the absence of proper access controls or data sanitization can lead to the unintended exposure of sensitive information, exacerbating risks to security and privacy.

### OVERVIEW

Technology is disclosed herein for incident data management in computing environments, including data collection, processing, distribution, and reporting, in various implementations. In one example, a method of responding to security incidents comprises receiving a record indicative of a security incident in computing environment; identifying one or more other records in the computing environment associated with the security incident; prompting a generative artificial intelligence (AI) model to generate redaction criteria, based on security incident data in the records, for redacting sensitive information from the security incident data; processing the security incident data based on the redaction criteria to produce redacted incident data; and prompting the generative AI model to generate a report of the incident based on the redacted incident data.

In another example, a computing apparatus comprising one or more computer readable storage media, one or more processors operatively coupled with the one or more computer readable storage media, and program instructions stored on the one or more computer readable storage media that, when executed by the one or more processors, direct the computing apparatus to at least receive a record indicative of a security incident in a computing environment; identify one or more other records in the computing environment associated with the security incident; prompt a generative AI model to generate redaction criteria, based on security incident data in the records, for redacting sensitive information from the security incident data; process the security incident data based on the redaction criteria to produce redacted incident data; and prompt the generative AI model to generate a report of the incident based on the redacted incident data.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for incident data management in an implementation.

FIG. 2 illustrates an incident data management process in an implementation.

FIG. 3 illustrates an operational architecture for incident data management in an implementation.

FIGS. 4A and 4B illustrate workflows for incident data management in an implementation.

FIG. 5 illustrates a workflow for contextualized redaction for incident data management in an implementation.

FIG. 6 illustrates a visualization of an incident map for incident data management in an implementation.

FIG. 7 illustrates a computing system suitable for implementing the various operational environments, architectures, processes, scenarios, and sequences discussed below with respect to the other Figures.

### DETAILED DESCRIPTION

Various implementations of technology including systems, methods, and software are disclosed herein for managing information relating to incidents impacting computing environments by which information about an incident, such as a data breach, a cyberattack, a system configuration issue, or a software defect, can be safely shared amongst multiple interested parties. Sharing such information promotes collaborative learning in pursuit of improving protections in handling sensitive information and improving systems or procedures relating to handling sensitive information. Because data about an incident may incidentally include sensitive information, the incident data to be shared to the various parties undergoes contextualized redaction to mitigate the risk of furthering the breach by accidental exposure of the sensitive information in the incident data.

Implementations of the technology include comprehensive collection of data relating to an incident occurring in a computing environment; dynamic redaction of the incident data; and summarization of the redacted incident data for the various audiences (e.g., management, engineering) with a particular interest in the information. In an implementation, the collection and handling of incident data includes an iterative, recursive process of collecting and mapping incident data (e.g., incident tickets, bug reports, internal communications) from sources such as incident response platforms of the computing environment. With the incident data collected, sensitive or confidential information is then redacted from the incident data based on contextualized redaction criteria. The dynamic redaction process includes identifying localized or context-specific search criteria for identifying sensitive terms for redaction as well as exceptions to redaction such as known safe terms. As more information about an incident (e.g., the spread of the incident to other clients of the computing environment, efforts to resolve the incident) is captured over time, the redaction criteria are updated in accordance with the new information. Thus, the redaction process continually adapts to the knowledge base about the incident to ensure that protections against accidental exposure of sensitive information are up-to-date.

In an implementation, having collected and redacted the incident data, summaries of the redacted incident data are generated for target audiences to allow sharing of information about the incident without inadvertently disseminating sensitive or confidential information. For example, the redacted incident information may be provided to a generative artificial intelligence (AI) model, such as a large language model (LLM), which is tasked with generating summaries of the incident data each of which is targeted for a specific audience and according to the type or classification of the incident (e.g., privacy breach, malware attack, software bug) and the specific component or area of the software product that is affected. In addition, the redacted incident data may be used for auditing the information handling of organizational entities for compliance violations with respect to handling sensitive information. If an exposure of sensitive information is detected in the incident data based on the dynamic redaction process, the system escalates a new privacy or security incident for further investigation. Further, the system may also be used to evaluate the effectiveness of the redaction process to improve the accuracy of the redactions, e.g., to be more or less inclusive in identifying sensitive information, particularly with respect to the specific audiences receiving incident information.

Generative AI models of the technology disclosed herein include large-scale models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Generative AI models capture general knowledge, semantic representations, and patterns and regularities in or from the data, making them capable of performing a wide range of downstream tasks. Examples of generative AI models include BERT (Bidirectional Encoder Representations from Transformers) and ResNet (Residual Neural Network). In some scenarios, a generative AI model may be pretrained or fine-tuned for specific tasks such as expanding a list of localized sensitive terms for redaction or generating summaries of redacted information for various audiences. Fine-tuning a generative AI model involves adjusting the parameters of the pretrained model according to a specific dataset to adapt the model’s output to a particular task. Types of generative AI models may be broadly classified as or include pre-trained models, base models, and knowledge models, depending on the particular characteristics or usage of the model. Generative AI models may be multimodal or unimodal depending on the modality of the inputs.

Multimodal models are a class of generative AI model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine).

Large language models (LLMs) are a type of generative AI model which processes and generates natural language text. LLMs are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type generative AI models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical effects of the technology disclosed herein include an information handling system for disseminating incident-related information to the various stakeholders or audiences within an organization to promote broader understanding of the incident but doing so in a way that protects against breaches in the handling of sensitive information. The dynamic redaction process involves continually updating the redaction criteria as more information about the incident is received so that the protections offered by the system are as current as the most recent incident data. Moreover, known safe terms are removed from the redaction criteria so that the redaction process does not obstruct knowledge sharing by being overly inclusive (i.e., removing too much information).

In addition to promoting the safe sharing of incident information, the technology provides an additional layer of protection against mishandling or accidental exposure of sensitive information by providing a mechanism to alert users to incident data containing sensitive data based on the dynamic redaction process. Further, the results of the dynamic redaction can be analyzed for violations of policies, regulations, or laws with regard to the handling of sensitive information, thereby protecting the confidentiality of the collected information and facilitating improvements in information handling.

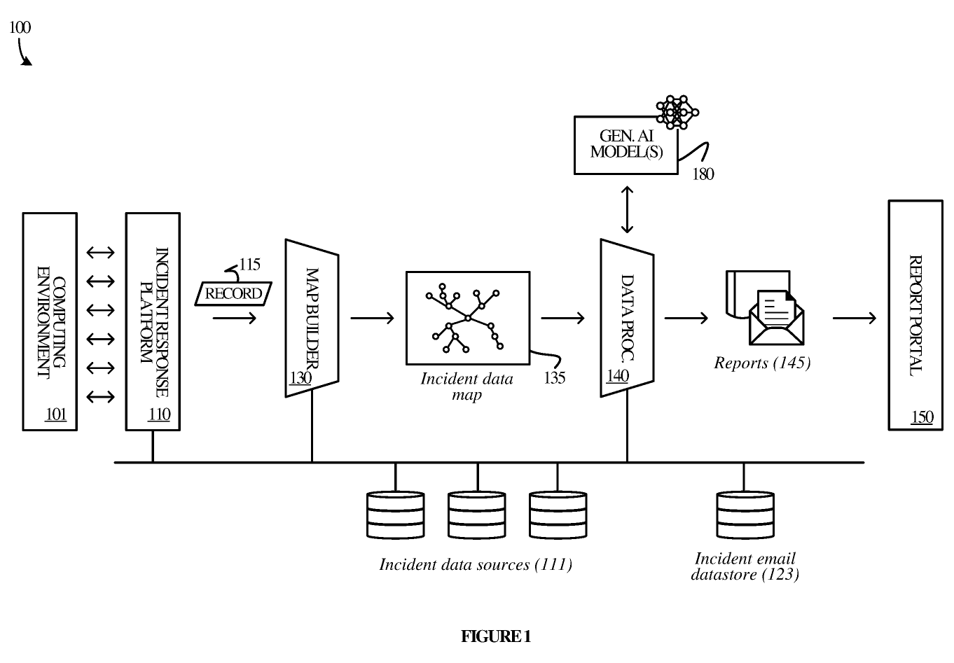

Turning now to the Figures, FIG. 1 illustrates operational environment 100 for contextualized redaction and sharing of incident information in an implementation. Operational environment 100 includes computing environment 101, incident response platform 110, map builder 130, data processor 140, report portal 150, and model 180. Operational environment 100 also includes incident data sources 111, incident email datastore 123, record 115, incident data map 135, and reports 145.

Computing environment 101 is representative of a cloud computing environment, an off-premises computing environment, an on-premises computing environment, or a hybrid computing environment with an information technology (IT) infrastructure for handling confidential or sensitive information such as personal identifying information (PII), end-user identifying information (EUII), proprietary content, customer content, attorney-client privileged information, or other confidential/sensitive information. Computing environment 101 includes hardware, software, networks, facilities and other technology-related resources for hosting IT services for enterprises such as productivity tools, collaboration platforms, communication tools, security and compliance systems, system analytics for data governance, and the like. Computing environment 101 may also include IT infrastructure services such as virtual machines, databases, and networking to support enterprise application development and deployment. Tenancies hosted in computing environment 101 may include organizations such as businesses, governmental agencies, healthcare or medical facilities, financial institutions, education institutions, and the like.

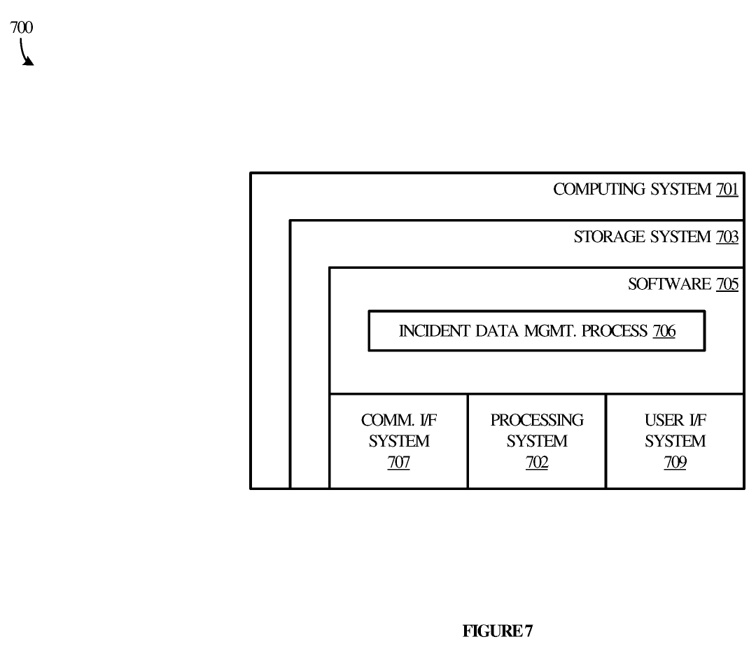

Incident response platform 110 (“response platform 110”) is representative of a service, such as internal or third-party service, implemented in software or hardware for incident management of a computing environment such as computing environment 101. For example, response platform 110 may be an incident management service of a broader IT services management platform. Response platform 110 includes tools for monitoring operations of computing environment 101 including tools for detecting security or privacy breaches, cyberattacks, software defects, or other incidents impacting computing environment 101. Response platform 110 may include a ticketing system to facilitate the manual or automated submission of service requests and incident notifications associated with the operations of computing environment 101. For example, if a user or monitoring tool in computing environment 101 detects a data breach in computing environment 101, the user or tool may submit a ticket to response platform 110 to initiate an investigation of the breach. Response platform 110 may persist incident data relating to an incident such as support tickets, change requests, work orders, and audit logs in a datastore or repository such as a repository of incident data sources 111. Response system 110 may execute on a computing apparatus of which computing device 701 of FIG. 7 is representative.

Map builder 130 is representative of a service or functionality implemented in software or hardware for collecting and mapping references to incident data relating to incidents (e.g., data breaches) impacting computing environment 101. Map builder 130 includes functionality to search for records of incident data (e.g., emails, tickets, reports) from datastores or repositories, such as incident data sources 111, of incident response systems or platforms. Map builder 130 includes functionality for generating a map of references (e.g., pointers, hyperlinks, file paths) to the records of incident data which traces the relationship (e.g., parent-child relationships) between the records and their sources (e.g., response platform, email). Map builder 130 may execute on a computing apparatus of which computing device 701 of FIG. 7 is representative.

In an exemplary scenario, map builder 130 queries response platform 110 and incident data sources 111 according to the metadata (e.g., header data, ticket number or identifier, routing information, day/time of record creation or submission, incident type or classification, reporting personnel or user, status, priority level, cross-references to other tickets) of an initial incident ticket. The initial incident ticket may have been autogenerated by a monitoring tool of response platform 110 or submitted by a user of computing environment 101 to response platform 110. Map builder 130 periodically re-queries response platform 110, incident data sources 111, and incident email datastore 123 based on the metadata of the initial ticket as well as the metadata of any collected incident data records. As records of incident data are identified, map builder 130 generates and refreshes a map of the records, such as incident data map 135, to include references to the newly discovered incident data, the sources of the incident data, and the relationships between the records.

Incident data map 135 is representative of a data structure for storing information about incident data, including references, such as pointers or hyperlinks, to records of incident data. Records of incident data can include incident management tickets, service tickets, support tickets, or change requests of a services management or incident management platform; bug reports, user stories, or task work items of a software development platform; documented communications such as emails, chat logs, transcripts; and so on. In various implementations, incident data map 135 includes metadata of the records by which map builder 130 searches incident data stores 111 and incident email datastore 123 for incident data. For example, map builder 130 may query the various sources of incident data according to a ticket number of an initial incident ticket and email address of the user submitting the ticket. As map builder 130 identifies new records of information relating to the incident, references to the new records are added to incident data map 135 in such a way as to indicate a source reference to which the new records are linked along with a type or source of the new records (e.g., a ticket of an incident response platform, a bug report of a software development platform). Recording the relationships between the records may be used to ensure data quality in the event of a data poisoning attack (e.g., a cross or in-direct prompt injection attack (XPIA) on a generative AI model). For example, in the event of an XPIA attack on incident data sources 111 communicated through generative AI model 180, the extent of the attack can be traced via the provenance or sourcing information captured in incident data map 135.

Data processor 140 is representative of a service or functionality implemented in software or hardware for processing data relating to incidents arising in computing environment 101. Data processor 140 may execute on a computing apparatus of which computing device 701 of FIG. 7 is representative. Data processor 140 includes functionality to generate redaction criteria for redacting incident data including global as well as localized or contextual redaction criteria. Data processor 140 also includes functionality for interacting (e.g., submit prompts and receive output) with a generative AI model (e.g., model 180), such as a prompt engine which generates prompts for the model based on prompt templates. For example, data processor 140 may prompt a generative AI model to produce a status report, email, or summary of an incident in natural language based on redacted incident data.

In an implementation, data processor 140 includes functionality to securely access incident data based on a map of records to incident data (e.g., incident data map 135) produced and maintained by map builder 130. In an implementation, data processor 140 uses a token-based authentication process to securely access the incident data from incident data sources 111 and incident email datastore 123. For example, data processor 140 requests a token from a data source identified in the map of incident data including a justification for the access; the token provided is time-restricted to protect the security of the data source. Providing a justification for access also facilitates verifiable auditing of the data collection and redaction process.

Report portal 150 is representative of a functionality by which output from data processor 140, such as reports 145, can be viewed or downloaded. Report portal 150 can include a repository of output such as summaries, reports (e.g., status reports, bug reports), or emails of redacted incident data. For example, contents of report portal 150 may be accessible in the user interface of a user computing device in communication with report portal 150.

Incident data sources 111 are representative of data stores or repositories associated with systems or platforms of computing environment 101 such as service management platforms, incident management platforms, software development and operations platforms, and the like. For example, incident data sources 111 may store records such as incident management tickets, service tickets, support tickets, or change requests of a services management or incident management platform; bug reports, user stories, or task work items of a software development platform; and the like. Records stored in incident data sources 111 may be manually entered (e.g., by a user, operator, or client of computing environment 101) or autogenerated, for example, by a monitoring tool of a service management platform. Incident data sources 111 may also include repositories for information sharing tools or systems of computing environment 101 such as communication channels for internal communication, collaborative applications, videoconferencing applications, and the like. For example, incident data sources 111 may include transcripts, recordings, or chat logs of meetings (e.g., videoconferences), meeting content analyses (e.g., summaries, to-do lists, action items, AI-generated output based on meeting content), shared documents, and so on.

Incident email datastore 123 is representative of a centralized storage to organize, manage, and retrieve email correspondence and related documents. Incident email datastore 123 may store emails associated with a system for managing incident data of a computing environment including emails associated with incident response platforms. For example, emails in incident email datastore 123 may include emails which are sent to a distribution list including an email address by which the emails can be identified for archiving by incident email datastore 123.

Model 180 is representative of one or more neural-network based, generative AI models including generative pretrained transformer (GPT) computing models or architectures, such as Dall-E, GPT-n, Claude, Gemini, Llama, or other types of deep learning architectures such as state-space models (e.g., Mamba). Model 180 is hosted by one or more computing services which provide services by which other elements of operational environment 100 can communicate with the model, such as an application programming interface (API). In communicating with other elements of operational environment 100, model 180 may send and receive information (e.g., prompts and replies to prompts) in data objects such as JavaScript Object Notation (JSON), eXtensible Markup Language (XML), or YAML Ain’t Markup Language (YAML) objects. Model 180 may be implemented in the context of one or more server computers co-located or distributed across one or more data centers.

An illustration of an operational scenario of operational environment 100 follows. Map builder 130 periodically queries response platform 110 for indications relating to incidents such as a data breach, cyberattack, software malfunction, etc., occurring in computing environment 101. A breach of sensitive information on computing environment 101 occurs, triggering submission of a service ticket to map builder 130. For example, a user of computing environment 101 may create a service ticket to flag the breach, or a monitoring tool of response platform 110 may detect a breach and generate a service ticket. The user may also send emails about the breach which are archived by incident email datastore 123.

Map builder 130 queries response platform 110 and receives record 115 which includes the service ticket. Map builder 130 initiates a process to identify other incident data relating to the breach from incident data sources 111 and incident email datastore 123, then creates incident data map 135 mapping references to incident data as it is identified, starting with record 115. As the incident evolves and the breach manifests in different ways, information relating to the breach may be generated or captured in different formats (emails, bug reports, incident management tickets, and so on).

Map builder 130 continues to periodically (e.g., daily) query response platform 110, incident data sources 111, and incident email datastore 123 for additional incident data based on the metadata of record 115 and the metadata of any already-identified records of incident data to create and then update incident data map 135. As additional incident data is identified, map builder 130 updates incident data map 135 to include pointers or references to newly identified records of incident data along with metadata of the records and the relationships between the records, such as grouping references according to the platform or entity sourcing the incident data or by “parent-child” relationships of records. Because a data breach may occur and evolve over a period of several days, the iterative querying for new incident data will cause incident data map 135 to grow during that time, becoming a comprehensive mapping of references to records of incident data for retrieval, collection, redaction, and analysis. After incident data map 135 has been updated, data processor 140 queries response platform 110, incident data sources 111, and incident email datastore 123 to collect the incident data for each of the references in the map for redaction. The collected incident data can include, for each record, the metadata of the record and information such as natural language comments or descriptive comment entered by a user. The collected incident data may also include attachments and references to other records about the incident, such as records from other platforms.

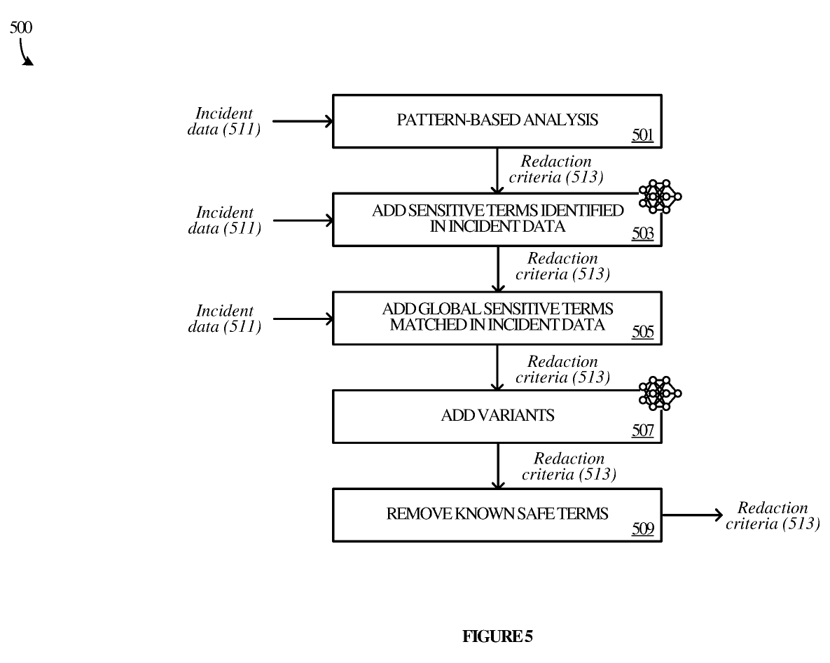

To redact the incident data, data processor 140 identifies redaction criteria including terms (e.g., strings, words, phrases, acronyms, abbreviations) that are to be redacted from incident data. The terms to be redacted from the incident data in a multi-step process (an implementation of which is illustrated in FIG. 5, discussed below) which identifies the terms for redaction based in part on contextual information embodied in the incident data. In one step of the process, a static, pattern-based analysis is performed by which patterns derived from a taxonomy of sensitive data types are matched to the incident data to identify sensitive data fragments. For example, data processor 140 may run a regular expression (“regex”) search of patterns for identifying web domains, subdomains, phone numbers, user aliases, user display names, email addresses, filenames, uniform resource locators (URLs), Internet Protocol (IP) addresses, media access control (MAC) addresses, street addresses, and the like. In addition to identifying terms from the incident data based on sensitive data patterns, the static analysis may also indicate a likelihood that the identified terms are indeed sensitive data. For example, user email addresses may be classified as “highly likely” to be sensitive information, while city and country names of street addresses may be classified as “moderately likely” to be sensitive. The identified terms and likelihood classifications resulting from the static analysis are added to the redaction criteria.

In another step of developing the redaction criteria, data processor 140 prompts model 180 to identify other terms in the incident data which are missing from the redaction criteria but which should be included based on being sensitive or potentially sensitive in view of the terms identified by the static analysis and their respective likelihood classifications. The prompt may specify a low temperature setting for more deterministic (i.e., less random) output. Model 180 returns sensitive terms similar to those captured by the pattern-based search but which eluded the pattern-based search based on typos, misspellings, informal abbreviations, variations, etc.

In another step of developing the redaction criteria, data processor 140 checks the incident data against a list of globally or historically sensitive terms which are determined to be sensitive regardless of context. The search may identify exact or literal matches of globally sensitive terms in the incident data. Any globally sensitive terms detected in the incident data are added to the redaction criteria.

In another step of developing the redaction criteria, data processor 140 prompts model 180 to expand the redaction criteria to include as many variations of each term in the redaction criteria as possible. Here, too, the prompt may specify a high temperature or highly deterministic output.

In another step of developing the redaction criteria, data processor 140 checks the terms of the redaction criteria against a list of known safe terms (e.g., “www.microsoft.com,” “wikipedia.com”) and removes any detected safe terms from the redaction criteria to prevent the redaction process from being overly restrictive.

With the redaction criteria developed, data processor 140 redacts the incident data based on the redaction criteria to produce redacted incident data. In redacting the incident data, the redacted terms are replaced with placeholders (e.g., placeholder terms) so that the shape of the incident data report does not change.

Next, data processor 140 prompts model 180 to generate one or more summaries or status reports about the incident based on the redacted incident data. Data processor 140 (or a prompt engine of data processor 140) may generate the prompt based on a prompt template which instructs model 180 to generate a summary or report for a particular audience (e.g., engineering, management, client) and in accordance with other parameters such as the type of incident (e.g., security breach, software defect). The prompt template may also specify that model 180 return its output in a parse-able format by which data processor 140 can extract specific elements of the output for autogenerating emails, populating fields in a user interface, or configuring the information for other forms of communication. With reports 145 generated, data processor 140 may store reports 145 in report portal 150 for retrieval by the respective parties.

The types of output which model 180 may be tasked with generating can vary according to the type of incident that is being documented. For example, reports 145 can include a high-level or condensed description of a software bug or its contents (e.g. a one paragraph summary) with the goal of quickly educating the interested parties about the bug. Reports 145 can also include the complete set of fully redacted incident data, particularly where the goal is to present the incident details as close to the original incident details as possible. By safely providing as much of the original incident information as possible, the readers receive a more complete picture of the incident including nuance, details, and context that might otherwise be lost or obscured, enabling a deeper understanding of the incident and its implications. In doing so, an incident data management system, such as the system embodied in FIG. 1, provides assurance that the incident information is safe for incident response teams to work with, allowing such teams to focus on the issue at hand rather than having to spend time on information protection tasks.

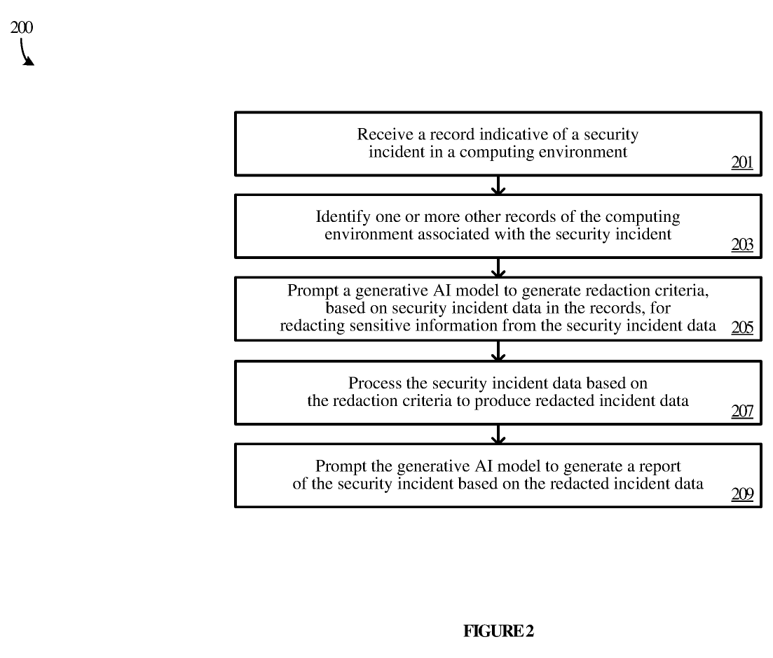

FIG. 2 illustrates a method of contextualized redaction and processing of incident data in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

The computing device receives an indication of a security incident in a computing environment (step 201). In an implementation, a computing device queries an incident response platform of the computing environment for information (e.g., service tickets) relating to security incidents and receives a service ticket indicating that an incident involving a security breach has been reported. The security incident may be a breach of data (e.g., sensitive or confidential information) involving unauthorized access to the data, a leak or exposure of data, a cyberattack (e.g., malware attack, ransomware attack), or other event that compromises the integrity, confidentiality, or availability of sensitive data or the information systems which handle sensitive data. Receiving the indication of the security incident initiates an investigation including incident data collection, redaction, and sharing so that various parties affected by the incident can be apprised of the situation in a manner which ensures that exposure of any sensitive information in the incident data is prevented.

The computing device identifies one or more other records of the computing environment associated with the security incident (step 203). In an implementation, the computing device queries data sources associated with platforms integrated in the computing environment for records of incident data relating to the security incident. The platforms integrated in the computing environment which may be queried include platforms for software application development or service platforms which manage security incidents occurring in the environment. Such platforms may include datastores or repositories for archiving records of information relating to security incidents. The computing device queries the platforms based on metadata (e.g., ticket numbers, incident classification, user email address) of the record indicating the security incident. The computing device may also identify emails relating to the incident according to the metadata. In response to the queries, the computing device may receive pointers, links, or identifiers for retrieving records identified by the queries as relating to the security incident.

The computing device prompts a generative AI model to generate redaction criteria, based on the security incident data in the records, for redacting sensitive information from the incident data (step 205). In an implementation, the computing device develops redaction criteria based on a multi-step process of identifying terms for redaction. The terms of the redaction criteria are identified based on rules derived from or patterns of common types of sensitive data matched in the security incident data, globally recognized sensitive terms matched in the incident data (e.g., a “block” list of sensitive terms), terms identified by a generative AI model based on the incident data or in view of the redaction criteria, and exceptions to redaction based on known safe terms (e.g., an “allow” list of safe terms or rules by which to identify safe terms in the redaction criteria based on patterns of known safe terms). In some scenarios, the computing device employs Retrieval-Augmented Generation (RAG) to prompt the model to generate or identify terms for redaction from the incident data. Using RAG, the computing device retrieves the incident data from the respective data sources and supplies the incident data in the prompt to the model.

In some scenarios, redaction criteria may be conditioned on the audience who will be receiving the redacted incident data. For example, some technical detail (e.g., IP addresses) may be necessary for an incident report for an engineering team but not for, say, clients of the computing environment. Thus, the redaction may be performed based on audience-specific redaction criteria to generate audience-specific redacted incident data.

The computing device processes the security incident data based on the redaction criteria to produce redacted incident data (step 207). In an implementation, the computing device retrieves incident data of the records associated with the security incident and executes a software application for redaction which matches the terms of the redaction criteria to the text in the incident data. When a term is identified in the incident data, it is redacted and replaced by a placeholder to maintain the shape of the incident data.

The computing device uses the generative AI model to generate a report of the incident based on the redacted incident data (step 209). In an implementation, the computing device generates a prompt which tasks the model with tailoring a report (e.g., a summary) of the redacted incident data for a particular audience so that the report includes the information most necessary or most relevant to the audience. The prompt may also task the model with generating its output in a parse-able format (e.g., according to field identified by semantic tags) by which the computing device can extract the information for display in a user interface, for auto-filling a report template or an email template, or the like.

In various implementations, steps of process 200 may be performed periodically (e.g., daily) as the security incident evolves. For example, the computing device may query the incident data sources of the computing environment based on the metadata of the service ticket as well as the already-identified records of incident data, then generate new or updated redaction criteria by which to redact an updated collection of incident data. In this way, daily incident reports, summaries, or emails may be generated to provide up-to-date information to the interested parties.

In some scenarios, the computing device may also perform an audit of the security incident data to mishandling of sensitive or confidential information in the incident data, such as identifying leaks of sensitive data in the incident data. For example, the computing device may track the redactions that were made to determine whether the redacted information was inappropriately included in the record. Similarly, the computing device may receive feedback from a user viewing an AI-generated summary indicating that too much information was left out to be useful to the user or that the summary includes information which should have been redacted. The process of generating the redaction criteria may be modified accordingly.

Referring again to FIG. 1, process 200 may be employed by elements of operational environment 100 in an implementation. In an exemplary scenario, map builder 130 periodically queries response platform 110 for indications of a security incident or potential security incident and receives record 115, such as an incident management ticket, which includes such an indication (e.g., an incident or ticket classification, keyword). Map builder 130 queries incident data sources 111 and incident email datastore 123 to identify other records of computing environment 101 associated with the security incident. Map builder 130 generates and update incident data map 135 which includes references to the records that are identified.

Having captured the records of computing environment 101 which are associated with the security incident, data processor 140 retrieves the incident data associated with the records and generates redaction criteria for redacting the incident data. To generate the redaction criteria, data processor 140 identifies terms for redaction based on patterns of known sensitive terms, then prompts model 180 to search the incident data for other terms of the same type but which were not captured by the pattern-based search. Data processor 140 also identifies global redaction terms in the incident data for inclusion in the redaction criteria. With the local and global redaction terms identified, data processor 140 prompts model 180 to identify variations on the terms in the redaction criteria for inclusion in the criteria. Data processor 140 then removes any known safe terms from the redaction criteria (e.g., by literal matches to known safe terms or by applying rules to identify safe terms in the redaction criteria based on patterns of known safe terms.

With redaction criteria generated, data processor 140 processes the incident data to remove the terms of the redaction criteria, yielding a set of redacted incident data. Data processor 140 prompts model 180 to generate output tailored for specific audiences to receive the information and configures the output for distribution, such as for display in a user interface or for download from report portal 150.

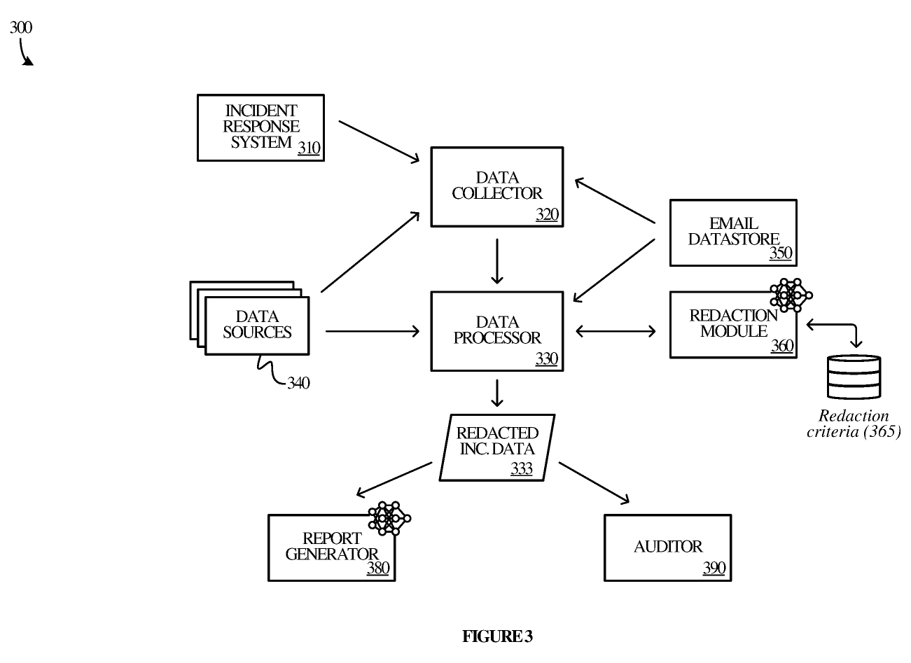

Turning now to FIG. 3, FIG. 3 illustrates operational architecture 300 for contextualized redaction and sharing of incident information in an implementation. Operational architecture 300 includes incident response system 310, data collector 320, data processor 330, redacted incident data 333, data sources 340, email datastore 350, redaction module 360, redaction criteria 365, report generator 380, and auditor 390.

Incident response system 310 is representative of a service, such as internal or third-party platform, for incident management of an IT environment or computing environment such as computing environment 101 of FIG. 1. For example, incident response system 310 may be an incident management service of a broader IT services management platform. Incident response system 310 includes tools for monitoring operations of a computing environment including tools for detecting security or privacy breaches, cyberattacks, software defects, or other events. Incident response system 310 includes a ticketing system to facilitate the manual or automated submission of service requests and incident notifications associated with the operations of the computing environment.

Data collector 320 is representative of a service or application for collecting and mapping records to data relating to incidents (e.g., anomalies) impacting a computing environment or infrastructure. Data collector 320 includes functionality to search for records of incident data (e.g., emails, tickets, reports) from data sources 340 and email datastore 350. Data collector 320 includes functionality to generate a map of references (e.g., pointers, hyperlinks, file path) to the records of incident data.

Data processor 330 is representative of a service or application for processing data relating to incidents arising in a computing environment. Data processor 330 includes functionality for securely accessing incident data based on a map of records of incident data maintained by data collector 320. In an implementation, data processor 330 uses a token-based authentication process to securely access the incident data from data sources 340 and email datastore 350.

Data sources 340 are representative of entities or platforms sourcing incident information or data relating to an incident such as a privacy or security breach, cyberattack, software bug, and the like. Data sources 340 can include entities such as an application or software development and operations platform, an incident management service, an email service, and the like. Data sources 340 may provide incident data in the form of service tickets, incident management tickets, bug reports, and email chains which include metadata such as ticket numbers or identifiers, service numbers, departments, and so on.

Email datastore 350 is representative of a repository for managing email correspondence. Email datastore 350 stores emails associated with incident data of a computing environment including emails associated with incident response system 310. For example, emails in email datastore 350 may include emails which are sent to an email address associated with email datastore 350. Data processor 330 may query and retrieve emails from email datastore 350 by an API hosted by email datastore 350.

Redaction module 360 is representative of a service or application for identifying terms for redaction from incident data collected by data processor 330 and redacting the incident data to produce redacted incident data 333. Redaction module 360 assembles or configures redaction criteria 365 which includes terms identified for redaction from the incident, for example, by process 500 of FIG. 5 (discussed below) including prompting a generative AI model to identify terms for inclusion in redaction criteria 365.

Redaction criteria 365 is representative of terms (e.g., strings, words, phrases, acronyms, abbreviations) that are to be redacted from incident data. Terms identified for redaction may be determined based on having been identified as confidential or sensitive; in some scenarios, terms may be identified for redaction based on toxicity, age-appropriateness, sensitivity (e.g., cultural or racial sensitivity), legality, relation to national security, or other criteria. Redaction criteria 365 may be organized in a list, array, vector, table, or other data structure.

Report generator 380 is representative of a functionality by which redacted incident data 333 is shared with interested parties, such as various entities or stakeholders affected by an incident occurring in a computing environment. Report generator 380 includes functionality to generate summaries of the redacted information which are tailored for specific audiences and according to the incident type. In an implementation, report generator 380 may include functionality for prompting a generative AI model to produce summaries of redacted incident data 333 which are tailored for particular audiences. The generative AI model may be instructed to generate its response in a structured or parse-able format by which information can be extracted for dissemination in a report, by email, etc.

Auditor 390 is representative of a functionality for identifying violations of sensitive data handling procedures occurring in the incident data. Auditor 390 includes functionality to detect or identify non-compliant data in records obtained or identified by data collector 320. When non-compliant data is identified, auditor 390 may escalate the violation for further investigation, for example, by submitting a request or notification (e.g., a service ticket) to incident response system 310 and including information by which to associate the detection of the non-compliant data with the initial incident record. Auditor 390 may also flag issues relating to access controls or permissions for a data source of a computing environment to prevent future violations.

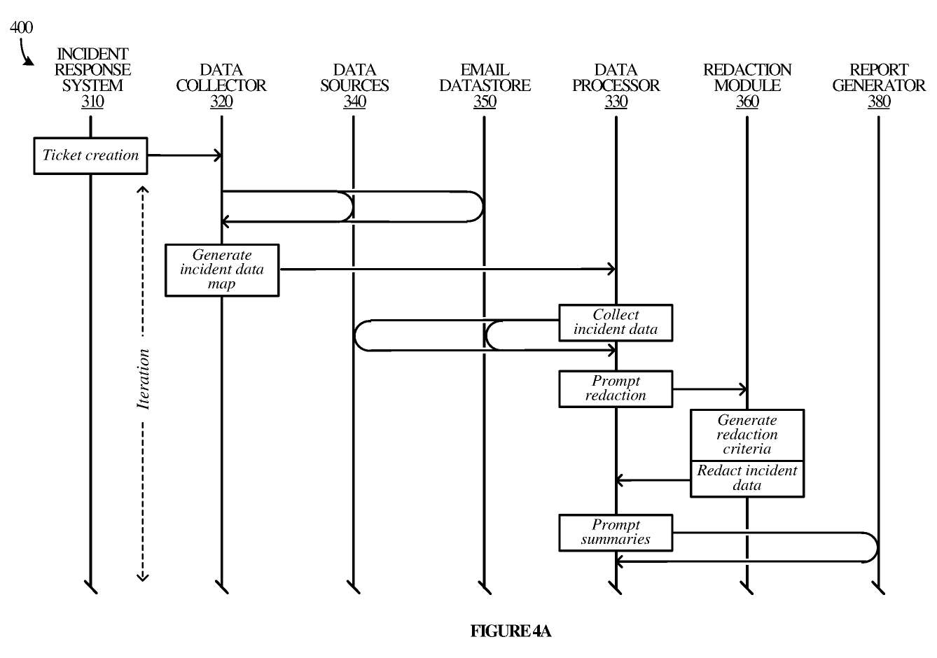

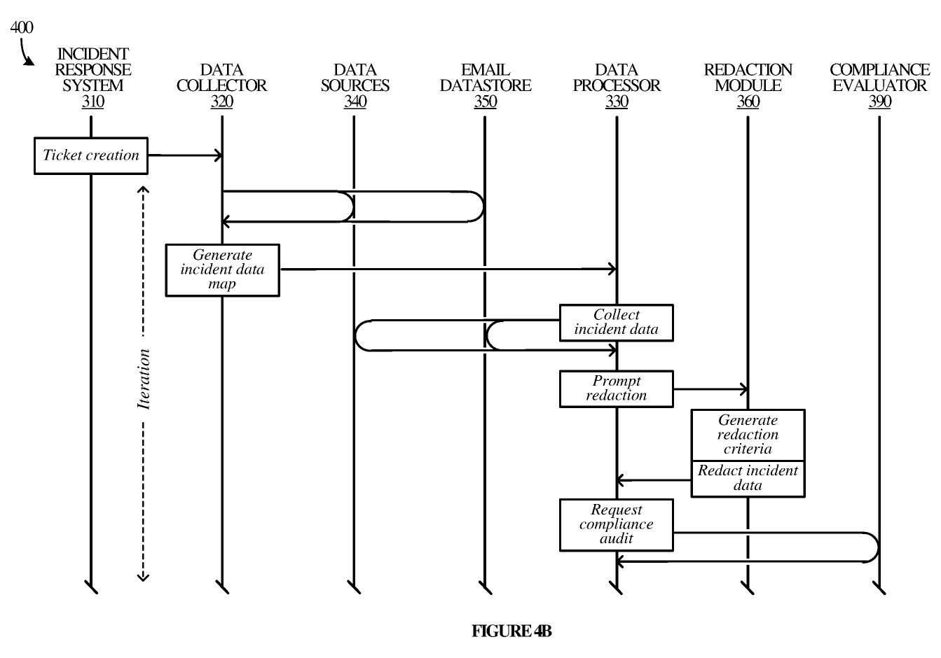

FIGS. 4A and 4B illustrate workflows 400 and 410, respectively, for contextualized redaction and sharing of incident data in an implementation and in reference to elements of operational architecture 300.

In workflow 400, service ticket is created in incident response system 310 which relates to a security incident occurring in a computing environment, such as a breach of sensitive or confidential information managed by the computing environment. The service ticket may be created and submitted by a user of the computing environment, or the ticket may be autogenerated by a monitoring tool of incident response system 310.

Data collector 320 queries incident response system 310 for indications of security incidents. In response to a query, data collector 320 receives the support ticket about the breach. Data collector 320 proceeds with capturing incident data relating to the breach from data sources 340 and email datastore 350. To identify incident data relating to the breach, data collector may query data sources 340 and email datastore 350 based on metadata from the service ticket. Based on the information returned from data sources 340 and email datastore 350, data collector 320 generates an incident data map which traces the information according to its source and the information (e.g., metadata of the source) by which the information was identified.

Data collector 320 periodically re-queries incident response system 310 and data sources 340 based on metadata of the service ticket and the metadata of already-identified records captured in the incident data map. As records relating to the breach are discovered, references to those records are added to the map, providing metadata for subsequent searches.

With incident data identified, data processor 330 receives the incident data map and retrieves the incident data from the respective sources of data sources 340 and email datastore 350. In various implementations, to retrieve the incident data, data processor 330 requests tokens (e.g., just-in-time or JIT tokens) for reading incident data from data sources 340. The tokens enable controlled access to data relating to business operations and operational flows of the organization. For example, data processor 330 may request an access token from a data source of data sources 340, such as development platform, including a justification for the access. The data source provides a token by which data processor 330 submits a request for one or more records specified in the incident data map.

With the incident data collected, data processor 330 prompts redaction module 360 to redact the incident data. Redaction module 360 generates redaction criteria 365 based in part on the incident data. The collected incident data is used to generate redaction criteria 365 so that the redaction criteria 365 includes terms which are localized or contextualized to the incident.

In various implementations, to generate redaction criteria 365, redaction module 360 executes a multi-step process which includes searching the collected incident data for terms which match patterns of commonly occurring sensitive data, terms which match a block list of global sensitive data, and terms which match an allow list of safe terms. The process may also include prompting a generative AI model to identify variations on the terms in redaction criteria 365 to capture terms that were overlooked by the pattern matching. With redaction criteria 365 generated, redaction module 360 redacts the incident data to produce redacted incident data which is returned to data processor 330.

Report generator 380 receives the redacted incident data and prompts a generative AI model to generate one or more reports based on the data. In an implementation, report generator 380 generates a prompt which tasks the generative AI model with generating reports or summaries of the redacted incident data which are tailored for specific audiences to highlight the information that is of particular relevance to the audience. The prompt may specify that the output of the model be in a parse-able format with specified fields so specific elements of the output can be extracted for generating emails, reports, and so on. Information derived from the redacted incident data may then be safely shared with different interested parties to promote learning to improve safeguards against future breaches.

In various implementations, the process of generating reports of the redacted incident data occurs periodically, such as daily, so that audiences are kept apprised of the status of the breach and efforts to resolve it. The process embodied in workflow 400 may continue until no new incident data is identified or until the amount of new incident identified falls below a threshold level.

FIG. 4B depicts workflow 410 which proceeds in the same manner as workflow 400, but which includes a request by data processor 330 for a compliance audit by auditor 390 based on the map of incident data and the redactions which were performed on the incident data. In various implementations, the incident data map may be used to audit internal or organization processes with regard to data handling. For example, if the incident data of a particular record has been redacted, the redaction may indicate an internal mishandling of sensitive information (although in some cases, the redacted information may have been appropriately included in the record).

In some implementations, auditor 390 generates a system audit or report card of how the incident management system is performing, including problems found through cross-examination (e.g., a person's email address should have been redacted but was not). For example, a redacted record may be compared to a rubric which specifies allowable types of sensitive data for given types of records. When a redaction indicates that sensitive data was inappropriately included in the record, auditor 390 may output a report or escalation ticket for further investigation. In some cases, auditor 390 may recommend or enact a change in permissions (e.g., revocation of access) of a reporting party to specified data sources based on the finding.

When the compliance evaluation identifies a potential leak or breach of sensitive information in the (unredacted) incident data, auditor 390 may submit a service ticket to incident response system 310 or send an autogenerated email to an interested party to trigger a second investigation. The second investigation may proceed in the same manner as the investigation of the initial breach—generating a reference map based on metadata of the service ticket and the offending incident data, and so on.

FIG. 5 illustrates process 500 for generating redaction criteria for redacting incident data in an implementation. In process 500, a system for incident data management executes a redaction application for redacting sensitive information from incident data collected from an IT environment or computing environment, such as service tickets, emails, and bug reports generated about a data breach, security incident, software defect, or other anomaly occurring in the computing environment. The redaction application may execute on a computing apparatus of which computing device 701 of FIG. 7 is representative.

The redaction application receives incident data 511 relating to a security incident which was collected from entities associated with a computing environment, such as a services management platform, a software development platform, an email system, or the like. The redaction application performs a static, pattern-based analysis of incident data 511 (step 501). The static analysis identifies sensitive information in incident data 511 according to patterns of known or common types of sensitive data. Such patterns may be based on Requests for Comment (RFC) standards of the Internet Engineering Task Force (IETF), National Institute of Standards and Technology (NIST) standards, or International Standards Organization (ISO) standards for handling sensitive or confidential information. The identified terms are added to redaction criteria 513.

The redaction application adds sensitive terms identified in incident data 511 to redaction criteria 513 (step 503). In an implementation, the redaction application prompts a generative AI model to review the list of terms identified by the static analysis and to expand the list to include terms of similar sensitivity from incident data 511 but which did not fit any of the patterns of the static analysis. The model may refer to the sensitivity classifications of the terms in the list together with its semantic understanding of incident data 511 to identify additional terms for inclusion in redaction criteria 513. The model may be a deep learning model which is pretrained or fine-tuned for sensitive data identification.

The redaction application adds global sensitive terms matched in incident data 511 (step 505). In an implementation, the redaction application compares a list of global or historical terms which are always redacted to incident data 511 and adds terms which are literal or exact matches found in incident data 511 to redaction criteria 513.

The redaction application adds variants to the terms in redaction criteria 513 (step 507). In an implementation, the redaction application prompts a generative AI model to review the list of terms in redaction criteria 513 thus far and to identify variations on the terms which should be redacted. Here, too, the model may be a deep learning model which is pretrained or fine-tuned for sensitive data identification.

The redaction application removes known safe terms from redaction criteria 513 (step 509). In an implementation, the redaction application compares the terms in redaction criteria 513 to a list of allowable terms that may have been identified for redaction and removes those terms from redaction criteria 513. The redaction application may also use pattern-matching to identify safe terms in the redaction criteria, for example, based on patterns of known safe terms. With the safe terms removed, the redaction application proceeds with redacting incident data 511 based on redaction criteria 513.

In some scenarios, process 500 includes multiple sets of redaction criteria that may be generated based on the audience which will be viewing redacted information. For example, the pattern-based analysis may be modified to allow certain types of sensitive or potentially sensitive information, such as IP addresses or MAC addresses, to remain in incident data 511 for engineering teams which will be receiving the information.

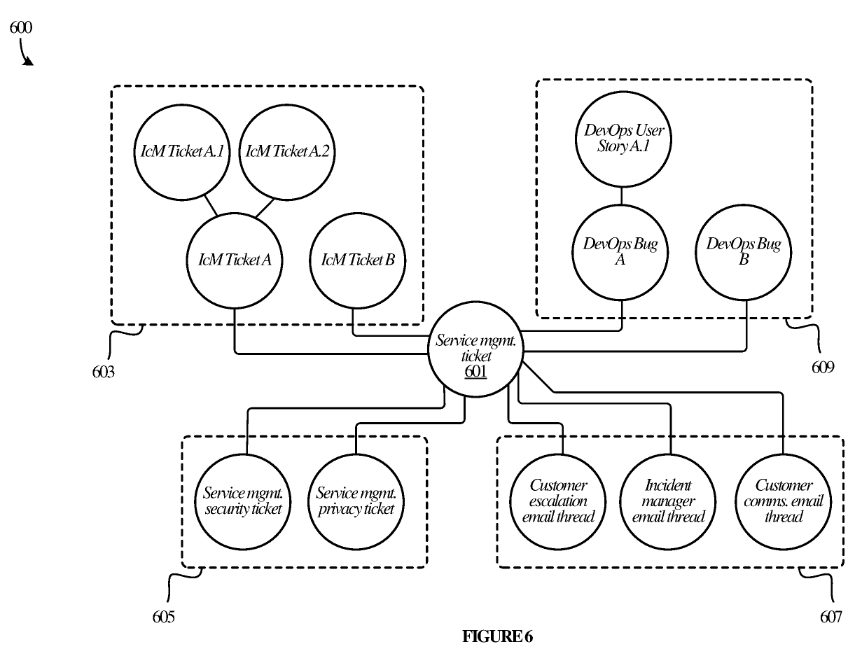

FIG. 6 illustrates visualization 600 of an incident data map produced by an incident data collector in an implementation. The incident data map depicted by visualization 600 includes nodes (e.g., node 601) representing records of incident data relating to an incident occurring in a computing environment, such as computing environment 101 of FIG. 1. The records incident data represented in visualization 600 may have been identified by a map builder application such as map builder 103 of FIG. 1 or an incident data collector application such as data collector 320 of FIG. 3. Node 601 represents an initial record indicating a security breach triggering the collection of incident data (in this illustration, a service ticket of a service management platform, such as incident response platform 110 of FIG. 1).

The interconnections of the nodes represent the “parent-child” relationships between the records, where searching by the metadata (not shown) of a “parent” record yields a “child” record. The searchable metadata may include identifiers (e.g., ticket numbers, email numbers, serial numbers) by which the records are threaded or connected. For a highly simplified example, searching a database of an incident management (“IcM”) platform for records which include or reference ticket identifier “A” of “IcM Ticket A” yielded two additional tickets. Thus, “IcM Ticket A.1” and “IcM Ticket A.2” were identified in a search of a database of the IcM platform based on the metadata of “IcM Ticket A,” which was previously identified in a search of the database based on metadata of the record of node 601.

The nodes depicted in visualization 600 are also organized by source type. For example, nodes 603 represent to records of an incident management platform; nodes 605 represent other records of the services management system; nodes 607 represent records of emails relating to an incident indicated by node 601; and nodes 609 represent bug reports and a user story of a software development and operations platform of the computing environment.

An operational scenario illustrating the generation and use of the incident data map of visualization 600 follows. An incident data system receives a service ticket (node 601) from a service management platform indicating an incident such as a breach of privacy or security information within a computing environment. As the effects of or information about the incident propagate through the computing environment, the incident data system initiates an investigation into the possibly far-ranging effects of the incident including gathering information about the incident, redacting the incident data, and sharing the redacted data to interested or involved parties.

During the investigation, the incident data system generates status reports or summaries of information about the data breach. For example, the incident data system may generate daily reports for various parties of the computing environment until the breach has been resolved. To generate the reports, the incident data system captures incident data from various data sources (e.g., service management platform, incident management platform, development and operations platform, email system) of the computing environment by identifying records of incident data according to metadata of the service ticket (node 601). When a record of incident data is identified as relating to the service ticket, a reference or node associated with the record is stored in the incident data map which tracks the relationships between the records of incident data. Metadata of newly identified records are used to identify still other records which are added to the map, and the process continues until no new records are identified.

With the incident data map generated, the incident data system collects the incident data corresponding to the records in the map. Prior to sharing information about the incident, the incident data must be redacted to remove any sensitive or potentially sensitive data. The incident data system generates redaction criteria based on terms identified in the collected incident data as well as related terms suggested by a generative AI model. The collected incident data is then redacted to remove the terms of the redaction criteria. Incident data system then prompts a generative AI model to generate status reports or other communications of the redacted incident information for specified audiences.

FIG. 7 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers (e.g., mobile devices, mobile phones), and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements incident data management process 706, which is (are) representative of the incident data management processes discussed with respect to the preceding Figures, such as processes 200 and 500 and workflows 400 and 410. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a microprocessor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements such as a controller capable of communicating with processing system 702 or possibly other systems.

Software 705 (including incident data management process 706) may be implemented in program instructions and among other functions may, when executed by processing system 702, direct processing system 702 to operate as described with respect to the various operational scenarios, sequences, and processes illustrated herein. For example, software 705 may include program instructions for implementing an incident data management process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support incident data management in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The following illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this Specification. As used below, any reference to a series of examples is to be understood as a reference to each of those examples disjunctively (e.g., “Examples 1-4” is to be understood as “Examples 1, 2, 3, or 4”).

Example 1 is a method of responding to security incidents, comprising: receiving, from a service platform associated with a computing environment, a record indicative of a security incident in the computing environment; identifying, in multiple data sources corresponding to multiple other service platforms associated with the computing environment, one or more other records associated with the security incident; generating an entity map that identifies at least the record, the one or more other records associated with the security incident, and the multiple data sources; obtaining security incident data from the multiple data sources using the entity map; generating redaction criteria, based on the security incident data, for redacting sensitive information from the security incident data; redacting the security incident data based on the redaction criteria to produce redacted incident data; and prompting a generative AI model to generate a report of the security incident based on the redacted incident data.

Example 2 is the method of any previous or subsequent example, wherein identifying the one or more other records in the computing environment comprises searching an incident data source of the computing environment based on metadata of the record, wherein the metadata comprises a ticket identifier.

Example 3 is the method of any previous or subsequent example, wherein prompting the generative AI model to generate the redaction criteria comprises generating a prompt for submission to the generative AI model, wherein the prompt comprises the security incident data and an instruction that tasks the generative AI model with identifying sensitive terms in the security incident data in view of the redaction criteria.

Example 4 is the method of any previous or subsequent example, wherein processing the security incident data based on the redaction criteria to produce the redacted incident data comprises: identifying terms of the redaction criteria which match terms in the security incident data; and replacing the identified terms with placeholder terms.

Example 5 is the method of any previous or subsequent example, wherein prompting the generative AI model to generate the report of the security incident based on the redacted incident data comprises generating a prompt including an instruction that tasks the generative AI model with tailoring the report according to a specified recipient and a type of the security incident.

Example 6 is the method of any previous or subsequent example, further comprising identifying terms from the incident data that match patterns of known sensitive terms to be added to the redaction criteria.

Example7 is the method of any previous or subsequent example, further comprising identifying terms from the incident data that match terms in a global block list for addition to the redaction criteria.

Example 8 is the method of any previous or subsequent example, further comprising: identifying terms of the redaction criteria which match known safe terms; and removing, from the redaction criteria, the terms which match the known safe terms.

Example 9 is the method of any previous or subsequent aspect, further comprising generating a service ticket based on determining that a record of the redacted incident data includes sensitive data.

Example 10 is a computing apparatus comprising: one or more computer readable storage media; one or more processors operatively coupled with the one or more computer readable storage media; and program instructions stored on the one or more computer readable storage media that, when executed by the one or more processors, direct the computing apparatus to at least: receive a record indicative of a security incident in a computing environment; identify one or more other records of the computing environment associated with the security incident; prompt a generative artificial intelligence (AI) model to generate redaction criteria, based on security incident data in the records, for redacting sensitive information from the security incident data; process the security incident data based on the redaction criteria to produce redacted incident data; and prompt the generative AI model to generate a report of the incident based on the redacted incident data.

Example 11 is the computing apparatus of any previous or subsequent example, wherein to identify the one or more other records in the computing environment, the program instructions direct the computing apparatus to search an incident data source of the computing environment based on metadata of the records, wherein the metadata comprises a ticket identifier.

Example 12 is the computing apparatus of any previous or subsequent example, wherein to prompt the generative AI model to generate the redaction criteria, the program instructions direct the computing apparatus to generate a prompt for submission to the generative AI model, wherein the prompt comprises the security incident data and an instruction that tasks the generative AI model with identifying sensitive terms in the security incident data in view of the redaction criteria.

Example 13 is the computing apparatus of any previous or subsequent example, wherein to process the security incident data based on the redaction criteria to produce the redacted incident data, the program instructions direct the computing apparatus to: identify terms of the redaction criteria which match terms in the security incident data; and replace the identified terms with placeholder terms.

Example 14 is the computing apparatus of any previous or subsequent example, wherein to prompt the generative AI model to generate a report of the security incident based on the redacted incident data, the program instructions direct the computing apparatus to task the generative AI model to tailor the report according to a specified recipient and a type of the security incident.

Example 15 is the computing apparatus of any previous or subsequent example, wherein the program instructions further direct the computing apparatus to identify terms from the incident data which match patterns of known sensitive terms for addition to the redaction criteria.

Example 16 is the computing apparatus of any previous or subsequent example, wherein the program instructions further direct the computing apparatus to identify terms from the security incident data that match terms in a global block list for addition to the redaction criteria.

Example 17 is the computing apparatus of any previous or subsequent example, wherein the program instructions further direct the computing apparatus to: identify terms of the redaction criteria that match known safe terms; and remove, from the redaction criteria, the terms that match the known safe terms.

Example 18 is a one or more computer-readable storage media having program instructions stored thereon that, when executed by one or more processors of a computing device, direct the computing device to at least: receive a record indicative of a security incident in a computing environment; identify one or more other records of the computing environment associated with the security incident; prompt a generative artificial intelligence (AI) model to generate redaction criteria, based on security incident data in the records, for redacting sensitive information from the security incident data; process the incident data based on the redaction criteria to produce redacted incident data; and prompt the generative AI model to generate a report of the incident based on the redacted incident data.

Example 19 is the one or more computer-readable storage media of any previous or subsequent example, wherein to identify the one or more other records in the computing environment, the program instructions further direct the computing device to search an incident data source of the computing environment based on metadata of the records, wherein the metadata comprises a ticket identifier.

Example 20 is the one or more computer-readable storage media of any previous or subsequent example, wherein to prompt the generative AI model to generate the redaction criteria, the program instructions direct the computing device to generate a prompt, wherein the prompt comprises the security incident data and an instruction that tasks the generative AI model with identifying sensitive terms in the security incident data in view of the redaction criteria.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of responding to security incidents, comprising:
receiving, from a service platform associated with a computing environment, a record indicative of a security incident in the computing environment;
identifying, in multiple data sources corresponding to multiple other service platforms associated with the computing environment, one or more other records associated with the security incident;
generating an entity map that identifies at least the record, the one or more other records associated with the security incident, and the multiple data sources;
obtaining security incident data from the multiple data sources using the entity map;
generating redaction criteria, based on the security incident data, for redacting sensitive
information from the security incident data;
redacting the security incident data based on the redaction criteria to produce redacted incident data; and
prompting a generative AI model to generate a report of the security incident based on the redacted incident data.

2. The method of claim 1, wherein identifying, in the multiple data sources corresponding to the multiple other service platforms associated with the computing environment, the one or more other records in the computing environment comprises searching an incident data source of the computing environment based on metadata of the record, wherein the metadata comprises a ticket identifier.

3. The method of claim 1, wherein prompting the generative AI model to generate the redaction criteria comprises generating a prompt for submission to the generative AI model, wherein the prompt comprises the security incident data and an instruction that tasks the generative AI model with identifying sensitive terms in the security incident data in view of the redaction criteria.

4. The method of claim 1, wherein generating the redaction criteria, based on the security incident data, for redacting the sensitive information from the security incident data comprises identifying terms of the redaction criteria which match terms in the security incident data and
replacing the identified terms with placeholder terms.

5. The method of claim 1, wherein prompting the generative AI model to generate the report of the security incident based on the redacted incident data comprises generating a prompt including an instruction that tasks the generative AI model with tailoring the report according to a specified recipient and a type of the security incident.

6. The method of claim 1, further comprising identifying terms from the incident data that match patterns of known sensitive terms for addition to the redaction criteria.

7. The method of claim 6, further comprising identifying terms from the incident data that match terms in a global block list for addition to the redaction criteria.

8. The method of claim 7, further comprising:
identifying terms of the redaction criteria which match known safe terms; and
removing, from the redaction criteria, the terms which match the known safe terms.

9. The method of claim 1, further comprising generating a service ticket based on determining that a record of the redacted incident data includes sensitive data.

10. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive a record indicative of a security incident in a computing environment;
identify one or more other records of the computing environment associated with the security incident;
prompt a generative artificial intelligence (AI) model to generate redaction criteria, based on security incident data in the records, for redacting sensitive information from the security incident data;
process the security incident data based on the redaction criteria to produce redacted incident data; and
prompt the generative AI model to generate a report of the incident based on the redacted incident data.

11. The computing apparatus of claim 10, wherein to identify the one or more other records in the computing environment, the program instructions direct the computing apparatus to search an incident data source of the computing environment based on metadata of the records, wherein the metadata comprises a ticket identifier.

12. The computing apparatus of claim 10, wherein to prompt the generative AI model to generate the redaction criteria, the program instructions direct the computing apparatus to generate a prompt for submission to the generative AI model, wherein the prompt comprises the security incident data and an instruction that tasks the generative AI model with identifying sensitive terms in the security incident data in view of the redaction criteria.

13. The computing apparatus of claim 10, wherein to process the security incident data based on the redaction criteria to produce the redacted incident data, the program instructions direct the computing apparatus to:
identify terms of the redaction criteria which match terms in the security incident data; and
replace the identified terms with placeholder terms.

14. The computing apparatus of claim 10, wherein to prompt the generative AI model to generate a report of the security incident based on the redacted incident data, the program instructions direct the computing apparatus to task the generative AI model to tailor the report according to a specified recipient and a type of the security incident.

15. The computing apparatus of claim 10, wherein the program instructions further direct the computing apparatus to identify terms from the incident data which match patterns of known sensitive terms for addition to the redaction criteria.

16. The computing apparatus of claim 10, wherein the program instructions further direct the computing apparatus to identify terms from the security incident data that match terms in a global block list for addition to the redaction criteria.

17. The computing apparatus of claim 10, wherein the program instructions further direct the computing apparatus to:
identify terms of the redaction criteria that match known safe terms; and
remove, from the redaction criteria, the terms that match the known safe terms.

18. One or more computer-readable storage media having program instructions stored thereon that, when executed by one or more processors of a computing device, direct the computing device to at least:
identify, in multiple data sources corresponding to multiple other service platforms associated with the computing environment, one or more other records associated with the security incident;
generate an entity map that identifies at least the record, the one or more other records associated with the security incident, and the multiple data sources;
obtain security incident data from the multiple data sources using the entity map;
generate redaction criteria, based on the security incident data, for redacting sensitive
information from the security incident data;
redact the security incident data based on the redaction criteria to produce redacted incident data; and
prompt a generative AI model to generate a report of the security incident based on the redacted incident data.

19. The one or more computer-readable storage media of claim 18, wherein to identify the one or more other records in the computing environment, the program instructions further direct the computing device to search an incident data source of the computing environment based on metadata of the records, wherein the metadata comprises a ticket identifier.

20. The one or more computer-readable storage media of claim 18, wherein to prompt the generative AI model to generate the redaction criteria, the program instructions direct the computing device to generate a prompt, wherein the prompt comprises the security incident data and an instruction that tasks the generative AI model with identifying sensitive terms in the security incident data in view of the redaction criteria.
